(19) United States
(12) Patent Application Publication
(10) Pub. No.: US 2019/0360455 A1
(43) Pub. Date: Nov. 28, 2019

(54) DEVICE AND TECHNIQUE FOR GENERATING POWER FROM MOVING WATER

(71) Applicant: Albert Magdi Iskander YOUSSEF, North Waikato (NZ)

(72) Inventor: Albert Magdi Iskander YOUSSEF, North Waikato (NZ)

(21) Appl. No.: 16/477,150

(22) PCT Filed: Jan. 10, 2018
(86) PCT No.: PCT/NZ2018/050002

§ 371 Date: Jul. 10, 2019

(30) Foreign Application Priority Data
Jan. 12, 2017 (NZ) 728260

(51) Int. Cl. F03B 17/06

(52) U.S. Cl. CPC F03B 17/063; F05B 2220/706; F05B 2240/244; F05B 2240/301; F05B 2240/932

(57) ABSTRACT

A water wheel turbine for generating power from a water current in a body of water, comprising multiple water wheels. The wheels have paddles, which have wings that channel the water current to a successive row of paddles on an adjacent wheel. The wings of the waterwheels work as self-barrier and director of the water current, reducing turbulence flow within the device. The gaps between the wings with the adjacent rear paddle do not create a significant resistance in the water current in front of the device compared with other waterwheel turbines. The device may operate in a body of water where it can be fixed or floating over a flume rigid foundation or over barrage foundation.

### BACKGROUND TO THE INVENTION

A variety of water wheels in a traditional concept are known in the art for generating power. All of them need walls or fixed barriers to direct and compress the water to them. In this invention a set of water wheels are fixed together in one axle each water wheel is designed to have an array of paddles, each paddle designed to have two wings to direct and compress the water to be directed to the adjacent rear paddles in the adjacent water wheel. Thus, no walls or barriers are needed any more for generating power from water wheels turbine.

### BRIEF SUMMARY OF THE INVENTION

In the present invention, the apparatus is for generating power from a water current in a body of water like river or tidal movement stream. The present invention comprises; a water wheel turbine, with winged paddles, for generating power. The turbine may either be fixed on a longitudinally extending floatation object for maintaining the turbine afloat in a body of water or on a solid permanent foundation with a water power generator, for generating power in response to a current in the body of water.

The turbine (the constitutional part) comprises multiple units wheels, each with multiple paddles. The wheels are fixed on the axle by a supporting structure beams that carry the paddles and its wings that all rotate around the axle by the force of the water current.

A single turbine is arranged with seven single wheels, each horizontally spaced along the axle, and each wheels alternately staggered with the adjacent wheel. Each wheel is fixed along the axle to make a space/gap with the adjacent wheel of paddles, so the wheel's paddles are aligned with the one after the adjacent. That makes the wheels aligned in a certain row be submerged together at the same time. Thus, as a portion of a water current flows against winged paddles in a given row, the water will flow through the spaces between the paddles to the left and right and initially towards winged paddles in the next row, this movement of the water current create diversion and compression to the flow to strongly hit the adjacent rear paddle, this movement occurs alternately.

A wheel comprises six winged paddles, and can be more or less in each wheel, each winged paddle has a plate in a trapezoid shape that has inner edge toward the axle longer than the outer edge, that will allow the wings to make a suitable space along the paddles wing edge with the adjacent rear paddles plates to the left and right in the adjacent wheel. So the water can go through it. The plate of the paddle has two wings from both longitudinal sides. The connection between the wings and the paddle plate is curved and the wing is connected into the plate in obtuse angle with the inner supporting rod face side, the inner edge of the wing near to the axle is shorter than the outer edge of the wing. This wings and its curved edges from both sides of the paddle makes the water to be transferred, redirected and compressed toward the adjacent winged paddle in a smooth flow, avoiding the turbulent movement in the water current. (that means saving energy to the adjacent paddles as the turbulent flow losses energy and making the head energy decrease). The gaps between the wings and the adjacent rear paddle hinder creating a significant resistance in the water current in front of the device compared with other waterwheel turbines, beside its other functions with the wings and paddles. A void and suction is created behind the winged paddles that will increase the torque power. This design makes the waterwheels winged paddles works as a self-water compressing device, (or as a water wheel with self-water barriers), thus we don't need to compress the water by building walls as the traditional waterwheels needs.

The water wheels winged paddles turbine and its way of working which serve in guide and self-compress the water current can be used in many devices. In this patent I will mention three of them. The First device is considered preferable in cases where water stream is needed to be opened for navigation or to be used for temporary power generation as it can be easy fixed and removed as the water wheels winged paddles will be fixed on a floating objects. In the second device it can be easily fixed over a water flume construction which is widely exist and used, operatively to be carried by the structure frame with a power generator box, but fixed over a flume rigid construction with rigid base for generating power. The third device operatively fixed over a rigid construction foundation of a barrage, advantageously with the addition of the water wheels winged paddles turbine it can produce a huge amount of energy.

### BRIEF DESCRIPTION OF THE DRAWINGS

FIG. 1 is a perspective view of a turbine rotor and a plurality of turbine winged paddles embodiment of the main part of the present invention.

FIG. 2 is perspective sideview of a single-waterwheel winged paddles without shaft from the embodiment shown in FIG. 1.

FIG. 3 is a perspective view of a single winged paddles wheel with a shaft of the embodiment shown in FIG. 1.

FIG. 4 is a perspective view of two winged paddles wheels with a shaft showing the difference in the fixing position between the first wheel and the second wheel on the shaft of the embodiment shown in FIG. 1.

FIG. 5 is a perspective view showing the relative positions of three wheels and the direction of the water current of the embodiment shown in FIG. 1.

FIG. 6 is a side elevation view of the units shown in FIG. 1.

FIG. 7 a perspective view of a single winged paddle unit out of the six winged paddles shown in FIGS. 2 and 3.

FIG. 8 a perspective view of a single winged paddle unit out of the six winged paddles shown in FIGS. 2 and 3 with more details.

FIG. 9 is a top view of a single winged paddle unit out of the six winged paddles shown in FIGS. 2 and 3.

FIG. 10 is a right perspective side view of FIG. 4.

FIG. 11 is perspective view of a proposed number of winged paddles wheels and a generator fixed over a floating carrier.

FIG. 12 is a perspective view from right side showing water level and direction of embodiment shown in FIG. 11.

FIG. 13 is a top view of embodiment shown in FIG. 11.

FIG. 14 is a perspective view of the floating and fixing frame of the embodiment shown in FIG. 11.

FIG. 15 is a front view of the floating and fixing frame of the embodiment shown in FIG. 11.

FIG. 16 is a side view of the embodiment shown in FIG. 11.

FIG. 17 is a front view of the embodiment of FIG. 1 fixed over a water flume

FIG. 18 is a perspective back side view represent numbers of water wheels winged paddles units shown in FIG. 1 fixed beside each other over a floating carriers, showing the water level and direction.

FIG. 19 is a perspective front view represent numbers of embodiment units shown in FIG. 1 fixed beside each other over a rigid barrage construction, showing the water level and direction.

FIG. 20 is a perspective front view represent numbers of water wheels winged paddles units shown in FIG. 1 fixed beside each other over rigid construction of a barrage shown in FIG. 19, without any water.

FIG. 21 is a close perspective view of the units shown in FIG. 20, showing the distance of the water wheels winged paddles and the rigid foundation.

FIG. 22 is a front view of the units shown in FIG. 20.

### DETAILED DESCRIPTION

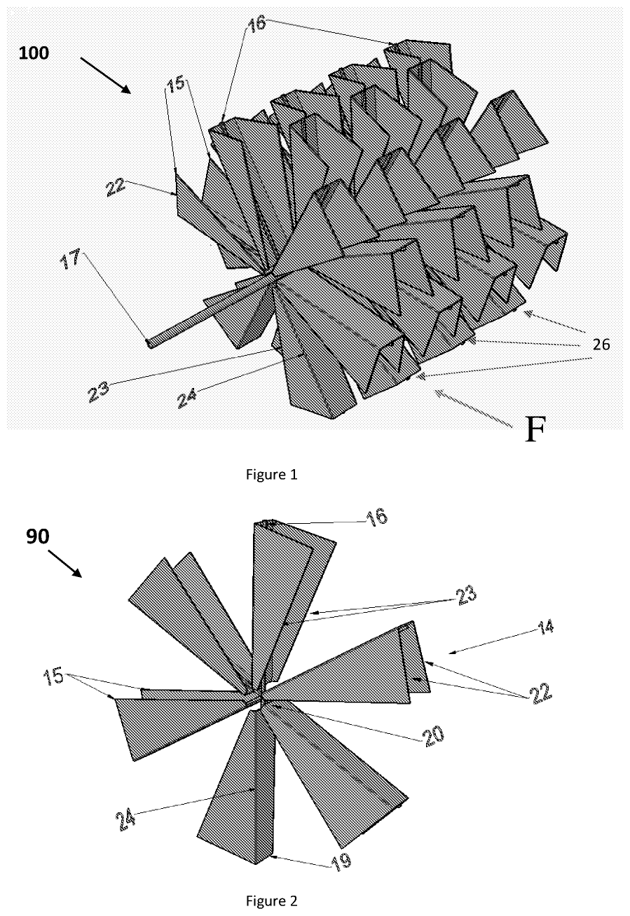

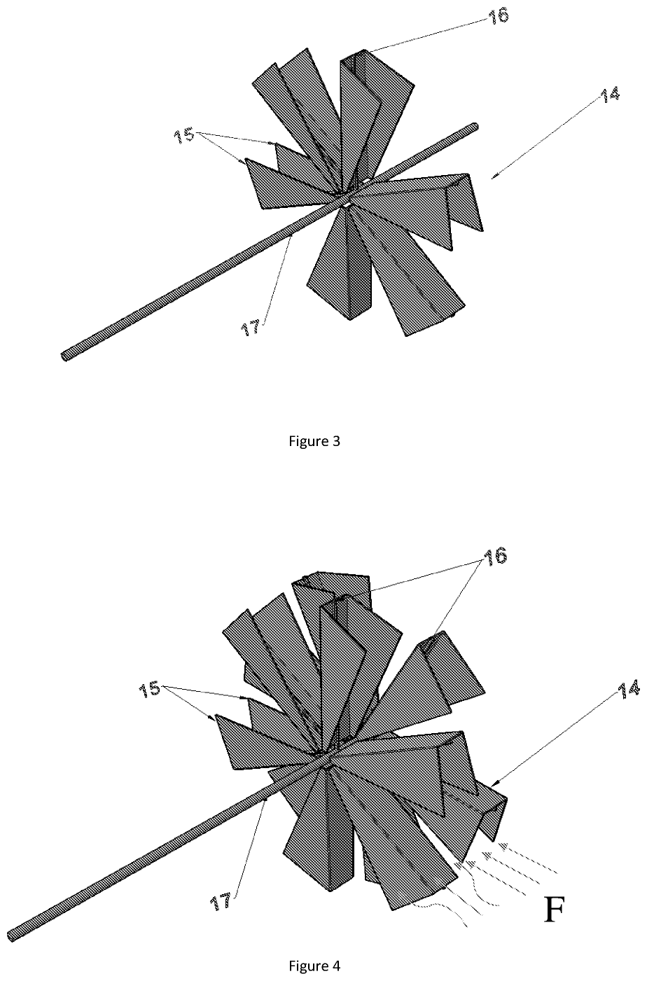

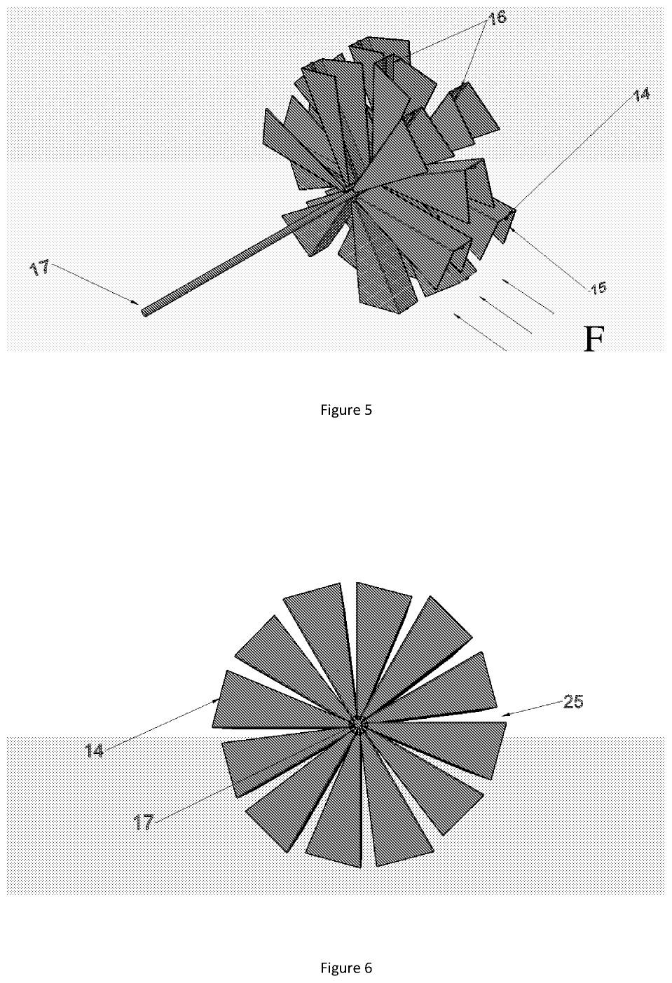

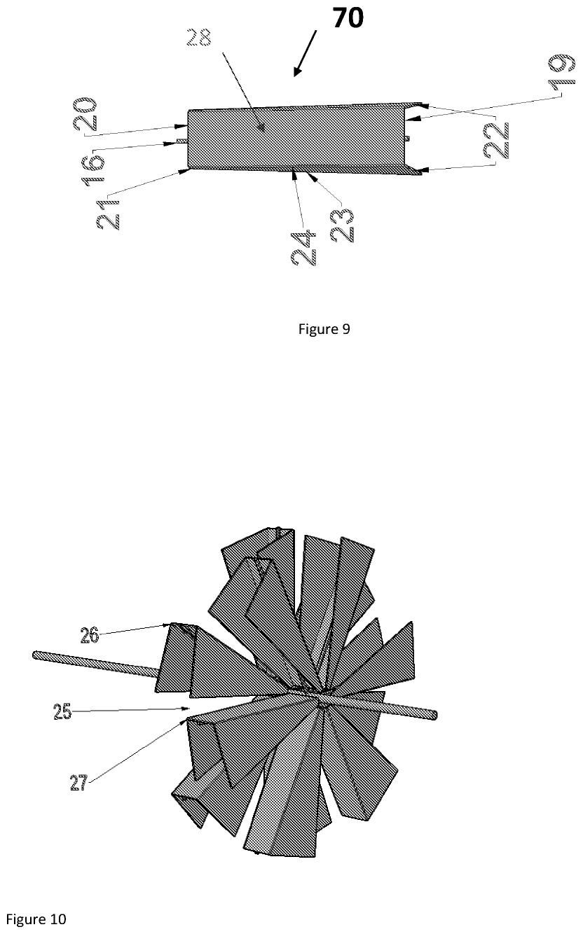

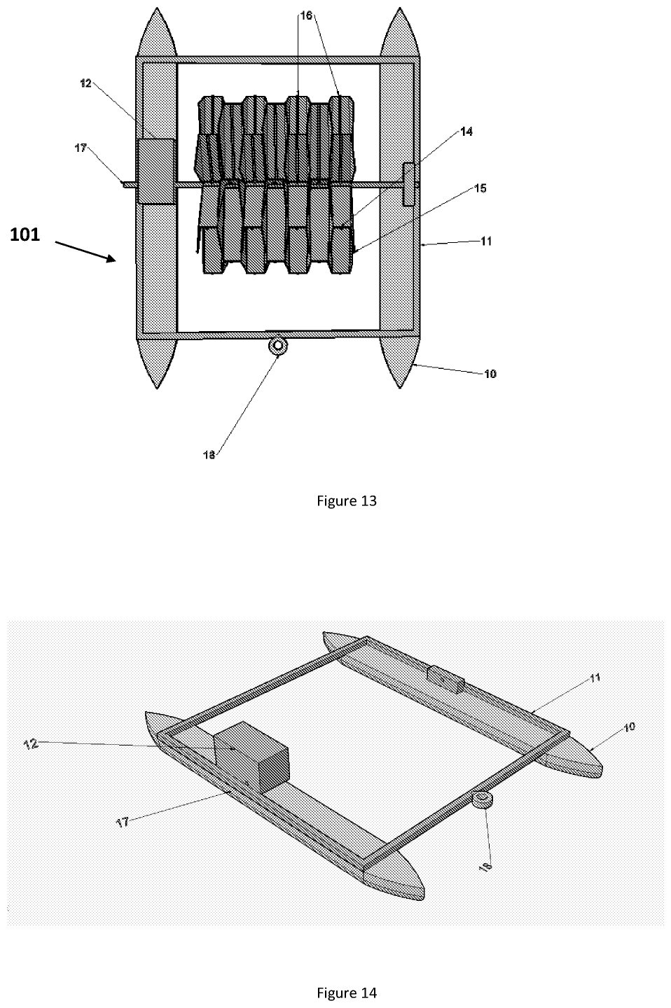

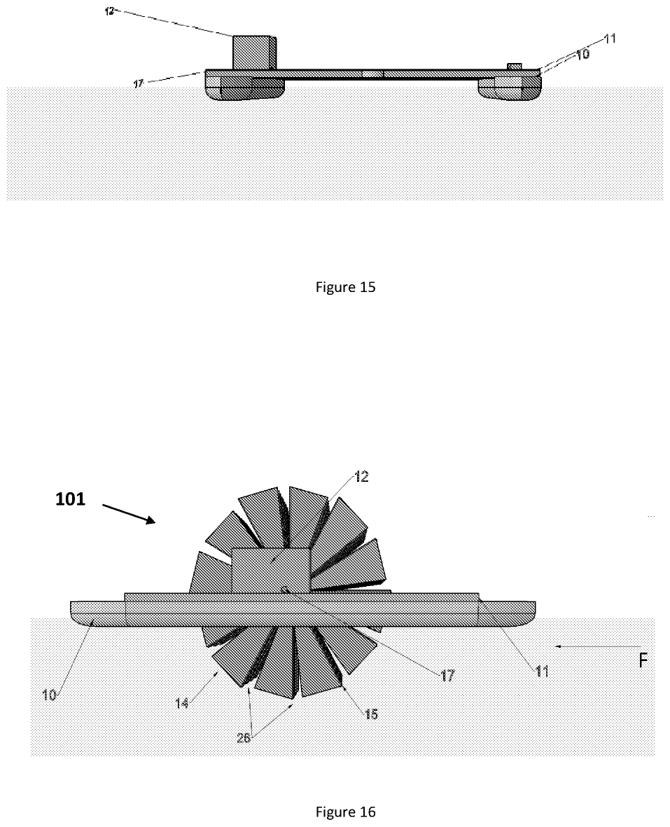

FIGS. 1-22 illustrate a turbine 100 for generating power either fixed on a longitudinally extending flotation object 10 for maintaining the station a float in a body of water (illustrated in FIG. 12 and FIG. 18) or on a solid permanent foundation 51 or 31 and a water power generator box 12, operatively carried by either floating objects 10 or solid 51 or 31 for generating power in response to a current in the body of water.

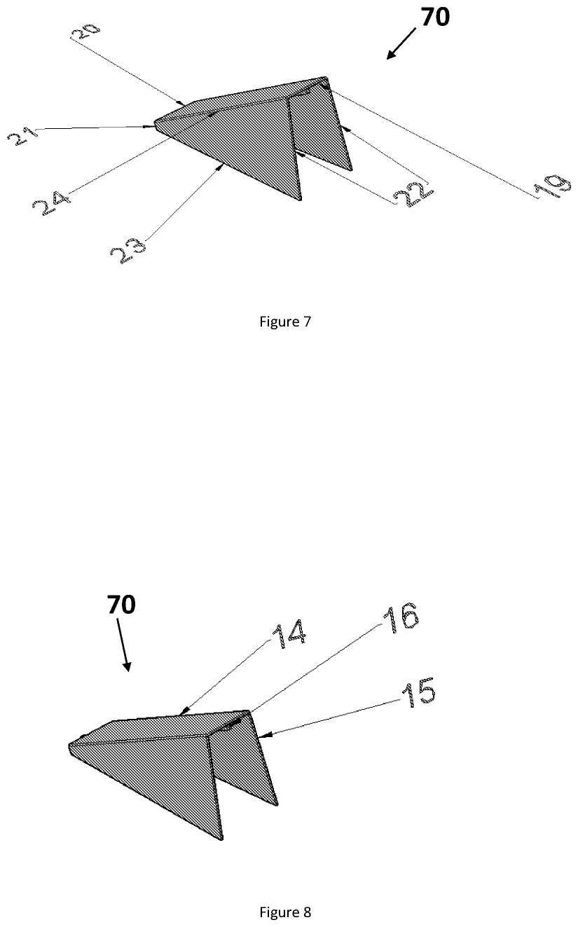

FIGS. 1-10 illustrate a turbine 100 (the main embodiment) comprising multiple wheels generally designated 90, an axle 17 and array of paddles 14 generally designated70, (these winged paddles detailed in FIGS. 7, 8 and 9) fixed on the axle 17 by a supporting structure beams 16 that carry the paddles 70. The paddles have wings 15 that extend radially from the axle 17. In operation, the wheels rotate clockwise (as shown in FIG. 4) by the force of the water current F.

In one embodiment seven wheels 90 of the turbine 100 are arranged in collinear, and horizontally spaced along the axle 17, paddles alternately staggered 26, 27, 26 . . . etc. (best seen in FIG. 10). Each wheel 90 is fixed along the axle 17 to make a space 25 (best seen in FIG. 6 and FIG. 10) with the adjacent wheel 90, so the wheel's paddles are aligned with the one after the adjacent. That makes all the wheels 90 aligned together and their paddles make a row of paddles to be submerged together at the same time (best seen in FIG. 1). Thus, as a portion of a water current flows against paddles 70 in a given row 26 for example, the water will flow through spaces 25 to left and right in the given row 26 and initially towards paddles 90 in the next row downstream 27 (best seen in FIG. 10), this movement of the water current create diversion and compression (channelling or funnelling) to the flow to strongly hit the adjacent rear paddle, this movement occurs alternately (wheels 90 at row position 26 compress the water current to the adjacent rear wheels 27). A cross section schematic view of a set of paddles 70 from a row 26 of two wheels 90, and a row 27 of a successive and adjacent wheel 90 is shown to show the fluid flow F funnelling through the gap 25 is shown in FIG. 10.

A wheel 90 (with winged paddles 70) (best seen in FIG. 2) comprises six paddle units 70, but can be more or less in each wheel 90 (seen in FIGS. 7, 8 and 9). Each paddle unit 70 has a plate 28 in a trapezoid shape that has inner edge 20, toward the axle 17, longer than the outer edge 19. This will allow the wings 15 to make a suitable space 25 along the paddles wing edge 23 with the adjacent rear paddles plates 28 to the left and right in the adjacent wheel so the water can flow through the space 25. The plate 28 of the paddle unit 70 has wings 15 on both sides. The connection 24 between the wings 15 and the plate 28 is curved. The wing 15 is connected (it can be integral) to the plate 28 at an obtuse angle with the plate 28 (in some embodiments, with a supporting rod 16). The inner edge 21 of the wing 15 is shorter than the outer edge 22 of the wing 15. The wing 15 and its curved connection 24 from both sides of the paddle 28 transfers, redirects and channels/funnels water towards the successive paddle unit 70 in a smooth flow, reducing the turbulent movement in the water current (that means saving energy to the adjacent paddles as the turbulent flow losses energy making the head energy decrease). A void and suction is created behind (intermediate the wings 15 of a paddle 70, and behind the plate 28) the paddle unit 70 that will increase the torque applied to the axle 17.

The wings 15 work to funnel the water current (best seen in FIG. 4 and FIG. 1). The wings 15 will channel the water current to the rear/successive row of paddle units 70 on an adjacent wheel(s) 90. The wheel's 90 paddle 70 design (i.e. the wings 15, best seen in FIG. 1) work as a channel/funnel, thus a need to channel the water by building walls as the traditional waterwheels is not needed.

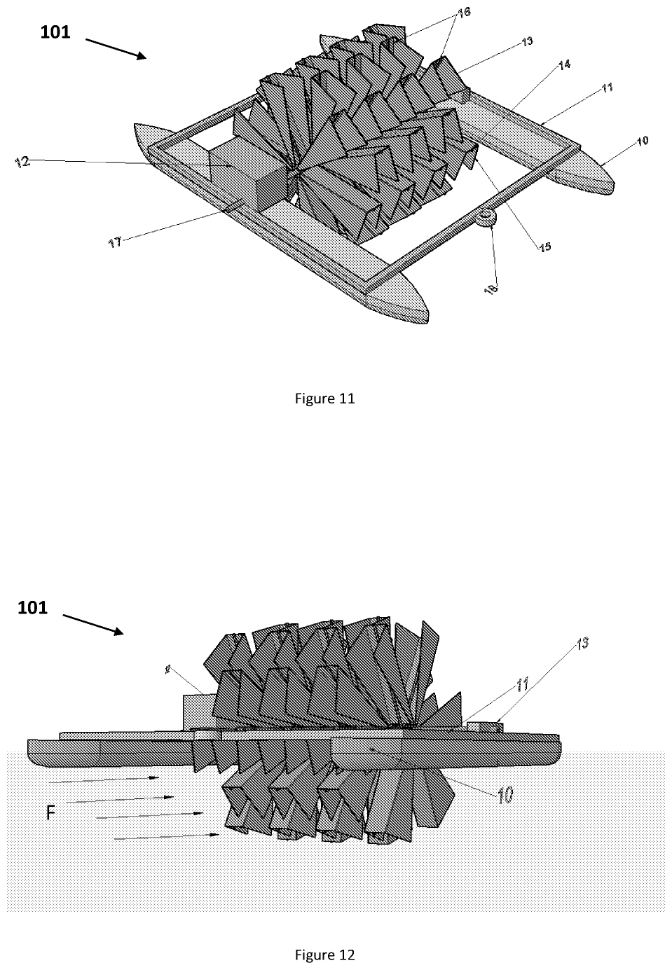

The first embodiment generally designated 101 (best seen in FIG. 11-16) is considered preferable in cases where water stream is needed to be opened for navigation and it is hard to construct a permanent foundation. The first embodiment 101 comprises longitudinally extended flotation units 10, structure frame 11 for joining the floating units 10, a water turbine 100, a power generator box 12 (another power generator box can be fixed symmetrically on the other side if desired) and a metal ring 18 to fix the mooring cable with its anchor (not shown) to be located on bed of the body of water.

The turbine 100 shown in FIG. 1 contains seven wheels. As shown in FIG. 2. The turbine 100 is not restricted to seven it can be more or less, and can be fixed on floating units 10 that connected together with structural frame 11 to join the floating units 10, wheels and power generation box 12 together in one unit generally designated 101. The wheels winged 90 are configured to rotate by the water current force F, the torque action transferred by the axle 17 that is connected to the generator box 12 to generate power.

In operation, the embodiment 101 is floated at a desired location in the current flow on body of water, the forward centroid apex where the metal ring 18 is fixed on the structure frame 11 being directed upstream in the water current flow in the direction opposite to arrow F, preferably at a point where the current is a maximum. Downstream movement of the embodiment 101 is restrained by securing mooring cable to an anchorage (not shown).

If desired, additional power generation embodiment 101 may be provided to be fixed side by side across the water current (best seen in FIG. 18). It is noted that the rectangular shape of the structure frame 11 allow to attach another similar embodiment 101 in a parallel way across the water current as many as needed side by side to form the embodiment generally designated 99.

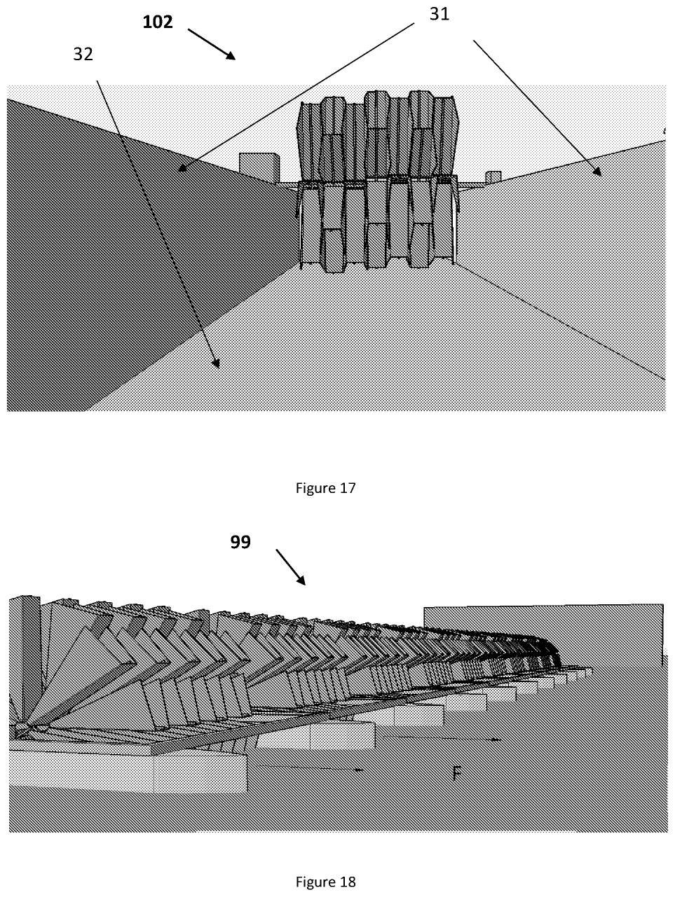

The second embodiment 102 (FIGS. 17) comprises a water wheels winged paddles turbine generally designated 100, operatively carried by the structure frame 11 with a power generator box 12, but fixed over a flume rigid construction 31 with rigid base 32 for generating power in response to a current in a body of water (not shown). The turbine 100 comprises a plurality of relatively big water wheels 90 extending outwardly from the axle 17 for operative communication with the water current. Axle 17 is journaled within journal box 12 mounted on the solid foundation 31 of the flume to generate power. In this way, we can control the water flow in the same time with generating power.

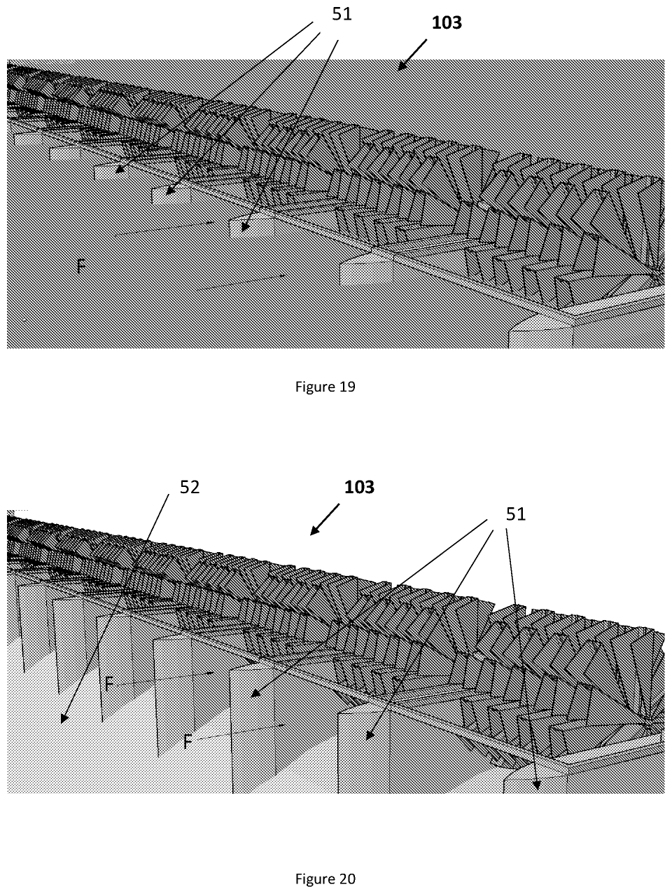

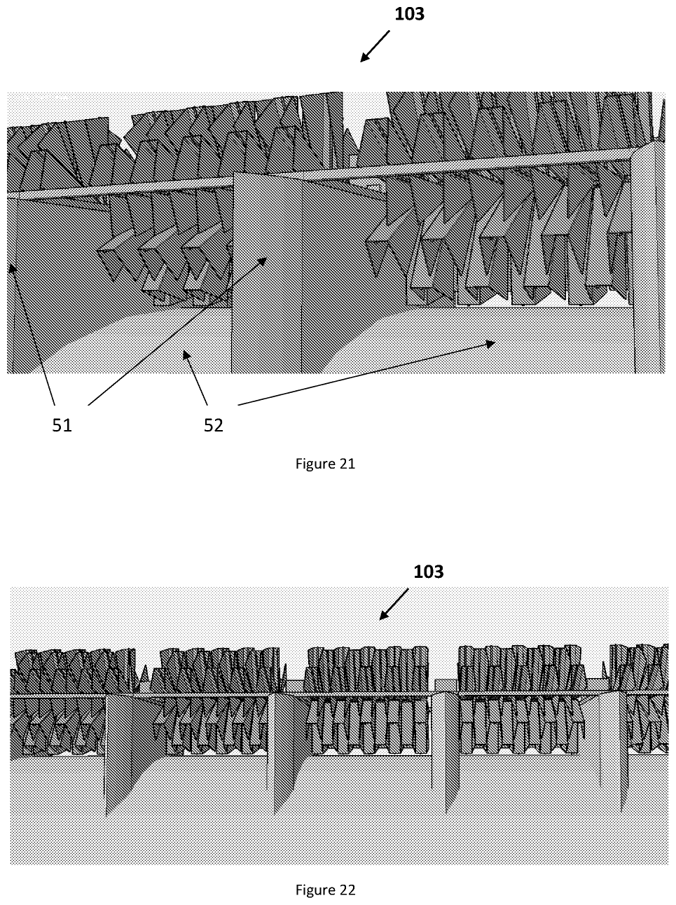

The third embodiment 103 (FIGS. 19-22) comprises a water wheels winged paddles turbine 100, operatively carried by the structure frame 11, but fixed over a rigid construction foundation of a barrage 51 with rigid base 52 for generating power in response to a current in a body of water F (best seen in FIG. 19). The turbine 100 comprises plurality of relatively big water wheels 90 extending outwardly from the axle 17 to a very close distance from the curved rigid base 52 for operative communication with the water current. Axle 17 is journaled within journal box 12 mounted on the solid foundation 51 of the barrage foundation to generate power, the turbine 100 is located in way to be as close as possible to the rigid barrage shoulders 51 and base 52 (best seen in FIGS. 21 and 22). The curves in the barrage construction as shown in FIGS. 20, 21 and 22 adding more compression and acceleration to the water current toward the turbine 100, on the other hand the wings of the paddles 15 itself adding more compression to the water current. Advantageously this way can control the water flow and water amount in the same time with generating power from many units 100 fixed on the barrage foundation cells as shown in FIG. 20.

The water wheels winged paddles turbine 100 and its way of working which serve in guide and self-compress the water current is used in the previously mentioned three embodiments. The first embodiment generally designated 101 (best seen in FIG. 11-16) is considered preferable in cases where water stream is needed to be opened for navigation or to be used for temporary power generation as it can be easy fixed and removed. The second embodiment 102 (FIG. 17) can be easily fixed over a water flume construction which is widely used, operatively to be carried by the structure frame 11 with a power generator box 12, but fixed over a flume rigid construction 31 with rigid base 32 for generating power. The third embodiment 103 (FIGS. 19-22) operatively carried by the structure frame 11, but fixed over a rigid construction foundation of a barrage. Advantageously the water wheels winged paddles turbine can produce a huge amount of energy.

The overall size of the water wheels winged paddles turbine 100 such as those represented on the floating and solid foundations may be substantial. For example, in an exemplary case, FIG. 11 has an overall length of about 70 m, and overall width of about 50 m, and an overall height over the body of water of about 17 m. The space between inner side of floating objects is about 35 m. Water wheels winged paddles FIG. 1 (seven water wheels winged paddles for example) has an outer drum diameter of about 30 m. The scale of the second and third embodiment may be similar except the absence of the floating objects 10 and its fixing items. Of course, it will be understood that overall dimensions, turbine size including paddles lengths and so forth may differ significantly from one case to the next. Applicable criteria will include rigid foundation, water depth, anticipated water current and desired power output.

A variety of modifications, changes and variations to the water wheels winged paddles turbine and the embodiments described are possible within the spirit and scope of the following claims and will be apparent to those skilled in the art. The invention is not restricted to the specific embodiments described herein.

1. An apparatus for generating power from a water current in a body of water, the apparatus comprising
a. an axle carrying at least three coaxially aligned and adjacent paddle wheels configured for rotating with the axle and in operating communication with said water current, each wheel comprising a plurality of paddles extending radially outward from the axle, each paddle comprising:
i. a plate bounded by an inner edge towards the axle, an outer edge radially distal the axle, and two side edges, the plate configured to be driven, to rotate the wheel in said first direction, by said current,
ii. a wing fixed to, or integral with, each side edge extending out from the plate towards said first direction,
wherein the wheels are fixed on the axle in a staggered way such that in operation at least one paddle in a given wheel will be submerged in the water current in succession after a paddle of the adjacent wheel is submerged, furthermore there is a gap laterally adjacent each wing to channel water to flow past the wing, to the adjacent and successive paddle of an adjacent wheel.

2. An apparatus as claimed in claim 1, wherein the laterally adjacent wings between two non-staggered paddles of adjacent wheels directs the flow of water in operation to the intermediate and successive paddle of the intermediate staggered wheel.

3. An apparatus as claimed in claim 1, wherein the apparatus comprises a supporting structure to support the axle and allow the wheels to communicate with the water current.

4. An apparatus as claimed in claim 1, wherein the apparatus is connected to a power generator via the axle for generating power from the rotation of the axle and wheels.

5. An apparatus as claimed in claim 3 wherein the supporting structure is floating.

6. An apparatus as claimed in claim 3 wherein the supporting structure is a rigid flume foundation.

7. An apparatus as claimed in claim 3 wherein the supporting structure is a barrage foundation.

8. An apparatus as claimed in claim 1 wherein apparatus does not need a barrier to direct water flow to it.
